(19) United States
(12) Patent Application Publication
(10) Pub. No.: US 2026/0197845 A1
(43) Pub. Date: Jul. 9, 2026

(54) CHANNEL ACCESS WITH ASSISTANCE INFORMATION FOR SIDELINK MODE-1 WITH UU-U AND SL-U

(71) Applicant: InterDigital Patent Holdings, Inc., Wilmington, DE (US)

(72) Inventors: Yifan LI, Conshohocken, PA (US); Pascal ADJAKPLE, Great Neck, NY (US); Umer SALIM, Vallauris (FR); Virgile GARCIA, Antibes (FR); Guodong ZHANG, Woodbury, NY (US); Kyle Jung-Lin PAN, Saint James, NY (US); Ravikumar PRAGADA, Warrington, PA (US)

(73) Assignee: InterDigital Patent Holdings, Inc., Wilmington, DE (US)

(21) Appl. No.: 19/130,427

(22) PCT Filed: Nov. 15, 2023
(86) PCT No.: PCT/US2023/079826

§ 371 Date: May 15, 2025

Related U.S. Application Data
(60) Provisional application No. 63/425,530, filed on Nov. 15, 2022.

(51) Int. Cl. H04W 72/25; H04W 28/02; H04W 74/0808

(52) U.S. Cl. CPC H04W 72/25; H04W 28/0278; H04W 74/0808

(57) ABSTRACT

A WTRU monitors a sidelink (SL) channel for communicating with a second WTRU in unlicensed SL mode-1 and collects SL assistance information relating to the SL channel. The WTRU transmits to a base station, over an unlicensed Uu band, one or more of a SL scheduling request (SR) or a SL buffer status report (BSR) and the SL channel assistance information. The WTRU receives downlink control information (DCI) from the base station indicating SL resource scheduling, performs listen-before-talk (LBT) on the SL channel associated with the indicated SL resource scheduling and sends a transmission: (1) to the base station, on a condition LBT is unsuccessful, at least one of indication of LBT failure or a request for new SL resource scheduling; or (2) to the second WTRU, on a condition LBT is successful, SL data using the indicated SL resource scheduling. Additional embodiments are disclosed.

### CROSS-REFERENCE TO RELATED APPLICATIONS

This application claims the benefit of U.S. Provisional Application No. 63/425,530, filed Nov. 15, 2022, the contents of which are incorporated herein by reference.

### BACKGROUND

Vehicle-to-everything (V2X) have been included in recent development of wireless technologies with a broader set of more advanced V2X use cases in mind. These are broadly described below in four use case groups including: vehicular platooning, extended sensors, advanced driving, and remote driving.

Vehicle Platooning enables vehicles to dynamically form a platoon while travelling together, e.g., in near proximity and in a similar direction. The vehicles in the platoon obtain information from the leading vehicle to manage this platoon. This information allows the vehicles to drive closer than normal in a coordinated manner, going to the same direction and travelling together.

Extended Sensors enable the exchange of raw or processed data gathered through local sensors or live video images among vehicles, road site units, devices of pedestrian and V2X application servers. The vehicles can increase the perception of their environment beyond of what their own sensors can detect and have a more broad and holistic view of the local situation. A high data rate is generally one of the primary characteristics for operation.

Advanced Driving features enable semi-automated or full-automated vehicle driving. Each vehicle and/or road-side-unit (RSU) may share its own perception data, obtained from its local sensors, with vehicles in proximity and allows vehicles to synchronize and coordinate their trajectories or maneuvers. Each vehicle may share its driving intentions with vehicles in proximity as well.

Remote Driving enables a remote person or machine, or a V2X application, to operate a vehicle remotely, e.g., for those passengers who cannot drive by themselves, or remote vehicles located in dangerous environments. For a case where variation is limited and routes are predictable, such as public transportation, driving based on cloud computing can be used. High reliability and low latency are primary concerns for this use category.

Each of the forgoing use cases may utilize sidelink (SL) transmissions between nodes that are scheduled by a central network over a Uu link. When both the Uu interface and the sidelink operate in unlicensed bands, the channel access is required on both the Uu and sidelink for SL mode-1 operation to complete a SL transmission scheduled by the base station through Uu link. Performing the channel access for Uu and sidelink independently may cause the gNB's SL scheduling to be inaccurate and inefficient due to the channel uncertainty on both Uu and sidelink. Therefore, mechanisms are need to support the gNB in improved scheduling on the sidelink unlicensed spectrum.

### SUMMARY

Embodiments described herein may provide improved sidelink (SL) operation for V2X scenarios. Examples of such improvements may relate to scheduling sidelink communications for channel access of a wireless transmit receive unit (WTRU) in a sidelink mode-1 unlicensed spectrum configuration to communicate with a network access station, directly or indirectly, via a Uu air interface in unlicensed frequency bands. According to one example embodiment, a channel access procedure may include communicating using unlicensed SL Mode-1 and unlicensed Uu without assistance information, but with pre-indication to send listen-before-talk (LBT) failure. In other example embodiments, methods of channel access for a remote WTRU communicating via unlicensed SL Mode-1 and unlicensed Uu channels to a network node, with assistance information from a relay WTRU (e.g., a transmit (Tx) WTRU), are disclosed. Further embodiments may relate to methods for communicating in a wireless network using a channel access procedure for unlicensed SL Mode-1 and unlicensed Uu with assistance information from a remote WTRU (e.g., a receive (Rx) WTRU).

According to one aspect, a method for a WTRU, may include monitoring a sidelink (SL) channel for communicating with a second WTRU in unlicensed SL mode-1 and collecting SL assistance information on the SL channel. The WTRU may transmit to a base station, over an unlicensed Uu band, a SL scheduling request (SR), a SL buffer status report (BSR) and/or the SL channel assistance information. The WTRU receives downlink control information (DCI) from the base station indicating SL resource scheduling and performs listen-before-talk (LBT) on the SL channel associated with the scheduled SL resources. The WTRU then sends a transmission: (1) to the base station, on a condition LBT is unsuccessful, and includes a request for a new SL resource scheduling; or (2) to the second WTRU, on a condition LBT is successful, using the indicated scheduled SL resources wherein the transmission includes SL data.

In certain aspects, prior to transmitting to the base station, the WTRU performs LBT on the unlicensed Uu band or receives an indication of a channel occupancy time (COT). In one example, when a Tx WTRU has data to transmit on the sidelink, the Tx WTRU performs channel access, e.g., LBT, on the sidelink and collects information. The Tx WTRU sends SR/BSR and the assistance information to the gNB to help the gNB determine the sidelink scheduling. The Tx WTRU monitors DCI and receives the sidelink scheduling and, optionally, Uu resources for sending sidelink LBT failure indication to the gNB. The WTRU performs LBT for the sidelink channel associated with the scheduled SL transmission. If the LBT is successful, the Tx WTRU performs the scheduled sidelink transmission to the Rx WTRU. If the LBT fails, the Tx WTRU sends LBT failure indication to the gNB using the Uu resources provided to do so. The WTRU then monitors and receives new/rescheduled sidelink resources from the gNB and performs sidelink LBT again.

According to some aspects, the SL assistance information may include a SL channel available start time, available SL candidate resources, a SL channel busy time, a SL channel available duration, a SL channel busy ratio (CBR) and/or an available SL sub-band indicator. In one example, the SL assistance information includes information regarding the SL channel received from the second WTRU. Additional embodiments are disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example representation communication range, rate, reliability and location accuracy of a vehicle present in a New Radio 5G V2X network coverage as contrasted with an LTE vehicle-to-vehicle (V2V) network coverage;

FIG. 3 illustrates an example of V2X sidelink mode 1 operation;

FIG. 4 is a flow sequence diagram illustrating a method of a wireless transmit and receive unit (WTRU) communicating in a wireless network according to one embodiment with a channel access procedure for sidelink unlicensed (SL-U) and a network air interface (Uu) in an unlicensed spectrum;

FIG. 5 is an example of a transmitting (Tx) WTRU report listen-before-talk (LBT) failure of the sidelink to a network access station (e.g., a gNB), using another resource prior to a scheduled physical uplink control channel (PUCCH) according to an embodiment;

FIG. 6 is a flow sequence diagram illustrating a method of a WTRU communicating in a wireless network according to an embodiment for a channel access procedure for SL-U in unlicensed Uu;

FIG. 7 is a flow diagram illustrating message sequencing in an example embodiment for a channel access procedure with assistance from the receiving (Rx) WTRU for communications in unlicensed bands for SL-U an Uu communications;

FIG. 8 is a flow diagram for an exemplary embodiment for WTRU communicating in SL-U mode 1 with early resource for sending LBT failure indication to a network access station (e.g., a gNB);

FIG. 9 is a flow diagram showing a method of communicating in a wireless network using SL-U mode 1 and channel access with assistance information from a relay/transmit WTRU according to an embodiment;

FIG. 10 is flow diagram illustrating example embodiments for communication in SL-U mode 1 and channel access with consolidated assistance information from the a relay WTRU (e.g., Tx UE) and a remote WTRU (e.g., Rx UE); and

FIG. 11 is a flow diagram illustrating a method for a base station perspective in performing communications in SL-U mode 1 with unlicensed Uu band using assistance information according to an embodiment.

### DETAILED DESCRIPTION

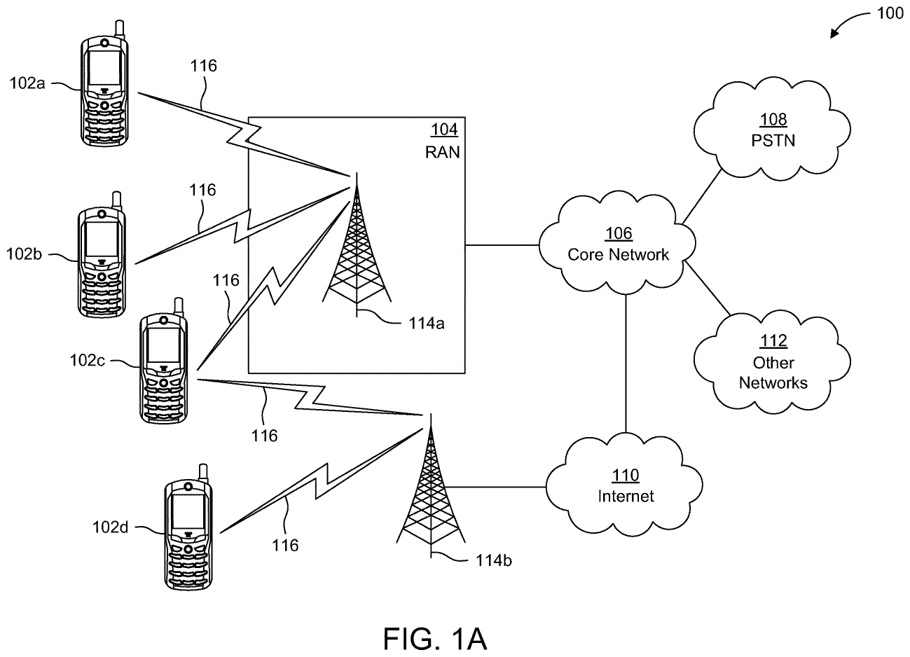

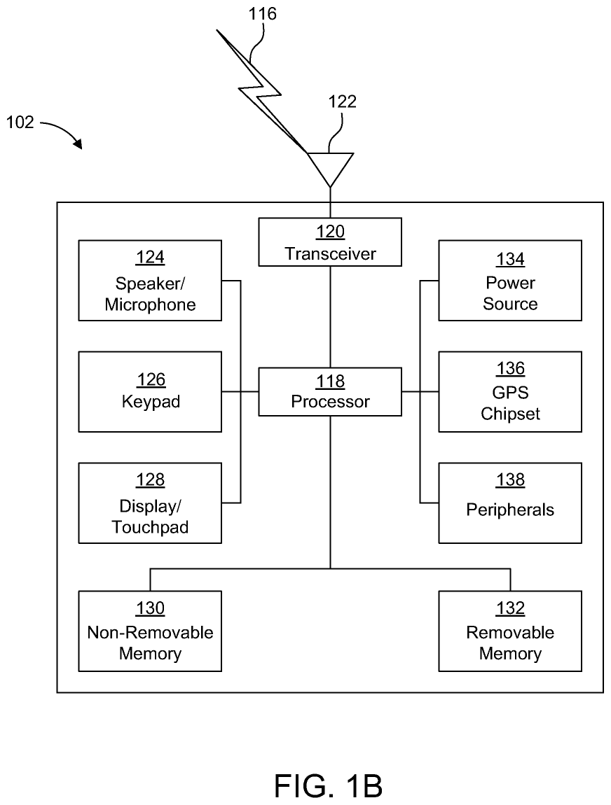

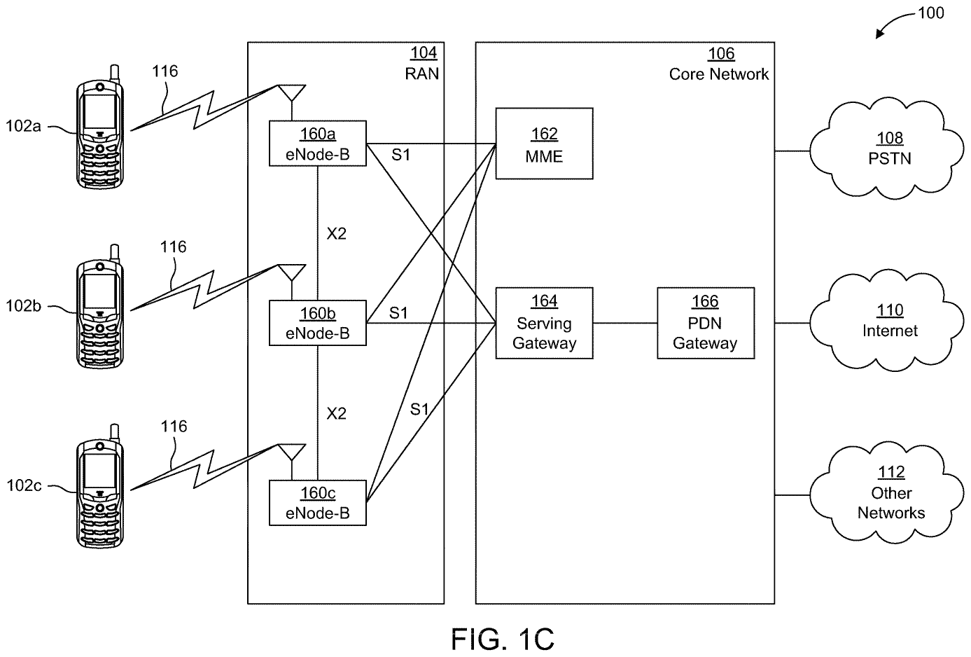

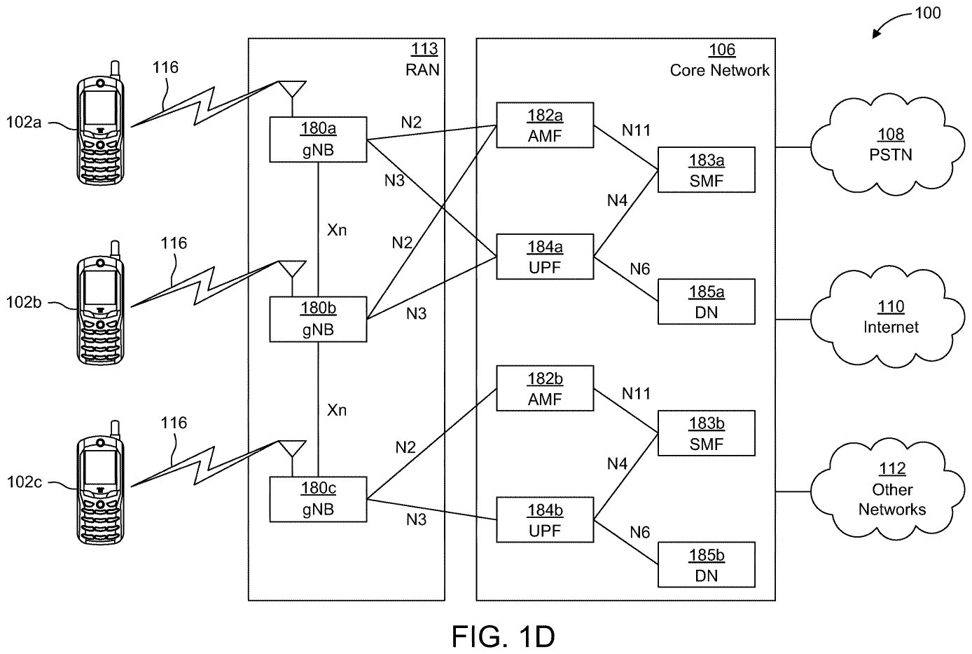

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology. FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

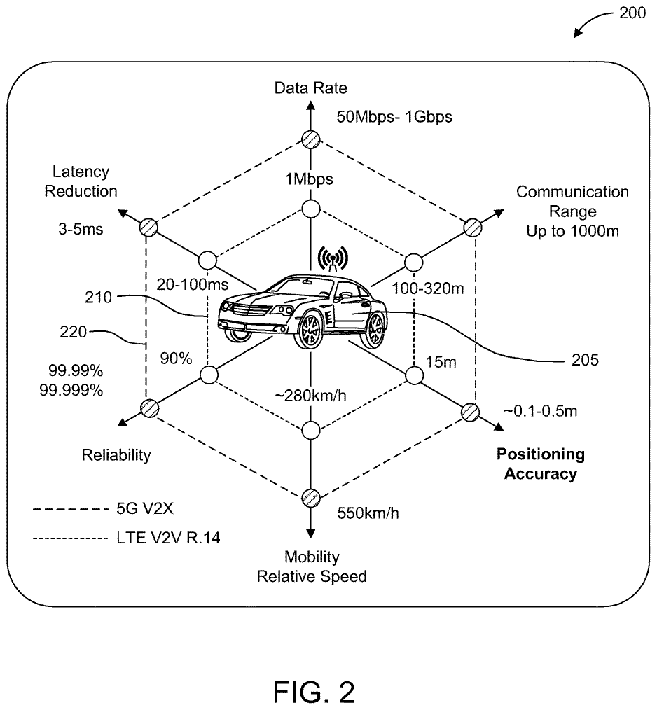

Referring to FIG. 2, an example diagram 200 of a vehicle 205 is shown in presence of different network types for vehicle communications is shown. In this example, the vehicle 205 is shown in a vehicle-to-vehicle V2V LTE radio access technology 210 as well as a new radio (NR) 5G vehicle-to-everything (V2X) radio technology 220. In this example, for NR V2X 220, demanding metrics are set including: a maximum sidelink range of 1000 meters, a maximum throughput of 1 Gbps; a latency of 3 ms; a maximum reliability of 99.999%; and a maximum transmission rate of 100 messages/second. Other challenging metrics may also include mobility relative speed and positioning accuracy. However, there is presently not a use case which, on its own, demands all of these bounding metrics. There may also be requirements relating to security, integrity, authorization, and privacy, not illustrated.

NR V2X defines a physical layer support for broadcast, unicast, and groupcast sidelink operation. Additionally, unicast and groupcast capabilities may be included with the introduction of sidelink HARQ feedback, high order modulation, sidelink CSI, and PC5-RRC, etc. It should be recognized, the specific examples presented herein are for understanding and the embodiments disclosed herein are not limited to any particular implementation.

The NR V2X sidelink may use the following physical channels and signals:
Physical sidelink broadcast channel (PSBCH) and its demodulation reference signal (DMRS);
Physical sidelink control channel (PSCCH) and its DMRS;
Physical sidelink shared channel (PSSCH) and its DMRS;
Physical sidelink feedback channel (PSFCH);
Sidelink primary and secondary synchronization signals (S-PSS and S-SSS) are organized into the sidelink synchronization signal block (S-SSB) together with PSBCH. S-PSS and S-SSS can be referred to jointly as the sidelink synchronization signal (SLSS);
Phase-tracking reference signal (PT-RS) in frequency band 2 (mmW), referred to as FR2; and
Channel state information reference signal (CSI-RS).

The NR-V2X sidelink supports subcarrier spacings of 15, 30, 60 and 120 kHz. Their associations to cyclic prefixes (CPs) and frequency ranges are as for NR UL/DL but using only the CP-OFDM waveform. The modulation schemes available are QPSK, 16-QAM, 64-QAM, and 256-QAM.

The PSBCH transmits the SL-BCH transport channel, which carries the sidelink V2X Master Information Block (MIB-V2X) from the RRC layer. When in use, the PSBCH transmits MIB-V2X every 160 ms in 11-resource blocks (RBs) of the SL bandwidth, with possible repetitions in the period. The downlink modulation reference signal (DMRS) associated with the PSBCH are transmitted in every symbol of the S-SSB slot. S-PSS and S-SSS are transmitted together with the PSBCH in the S-SSB. Jointly, they convey the SLSS ID used by the WTRU.

Sidelink control information (SCI) in NR V2X is transmitted in two stages. The first-stage SCI is carried on the PSCCH and contains information to enable sensing operations, as well as information about the resource allocation of the PSSCH.

The PSSCH transmits the second-stage SCI and the SL-SCH transport channel. The second-stage SCI carries information used to identify and decode the associated SL-SCH, as well as control for hybrid automatic repeat request (HARQ) procedures, and triggers for channel state information (CSI) feedback, etc. The SL-SCH carries the transport block (TB) of data for transmission over the SL.

The resources in which the PSSCH is transmitted can be scheduled or configured by a network access station, e.g., a gNB, or determined through a sensing procedure conducted autonomously by the transmitting WTRU. A given transport block (TB) can be transmitted multiple times. The DMRS associated with rank-1 or rank-2 PSSCH can be transmitted in 2, 3, or 4 sidelink symbols distributed through a sidelink slot. Multiplexing between the PSCCH and the PSSCH may be in time and frequency within a slot.

The PSFCH carries HARQ feedback over the sidelink from a WTRU, which is an intended recipient of a the PSSCH transmission (henceforth an Rx WTRU or Rx UE) to the WTRU which performed the transmission (henceforth a Tx WTRU or Tx UE). Sidelink HARQ feedback may be in the form of conventional ACK/NACK, or NACK-only with nothing transmitted in case of successful decoding. The PSFCH transmits a Zadoff-Chu sequence in one physical resource block (PRB) repeated over two OFDM symbols, the first of which can be used for automatic gain control (AGC), near the end of the sidelink resource in a slot. The time resources for the PSFCH may be (pre-)configured to occur once in every 1, 2, or 4 slots.

Resource allocation modes will now be described. Mode-1 is for resource allocation by the network access station/gNB. The use cases intended for NR V2X can generate a diverse array of periodic and aperiodic message types. Therefore, resource allocation mode-1 provides dynamic grants of sidelink resources from a gNB, as well as grants of periodic sidelink resources configured semi-statically by the RRC.

A dynamic sidelink grant DCI can provide resources for one or multiple transmissions of a transport block, in order to allow control of reliability. The transmission(s) can be subject to the sidelink HARQ procedure if that operation is enabled.

A sidelink configured grant can be such that it is configured once and can be used by the WTRU immediately, until it is released by RRC signaling (known as Type 1). A WTRU is allowed to continue using this type of sidelink configured grant when beam failure or physical layer problems occur in NR Uu until a radio link failure (RLF) detection timer expires, before falling back to an exception resource pool. The other type of sidelink configured grant, known as Type 2, is configured once but cannot be used until the gNB sends the WTRU a DCI indicating it is now active, and only until another DCI indicates de-activation. The resources in both types are a set of sidelink resources recurring with a periodicity which a gNB will desire to match to the characteristics of the V2X traffic. Multiple configured grants can be configured, to allow provision for different services, traffic types, etc.

Modulation and coding scheme (MCS) information for dynamic and configured grants can optionally be provided or constrained by RRC signaling instead of the traditional DCI. RRC can configure the exact MCS the Tx WTRU uses, or a range of MCS. It may also be left unconfigured. For the cases where RRC does not provide the exact MCS, the transmitting WTRU is left to select an appropriate MCS itself, based on the knowledge it has of the TB to be transmitted and, potentially, the sidelink radio conditions.

Mode-2 is for WTRU autonomous resource selection, i.e., without centralized network control. Its basic structure is of a WTRU sensing, within a (pre-)configured resource pool, which resources are not in use by other WTRUs with higher priority traffic and choosing an appropriate amount of such resources for its own transmissions. Having selected such resources, the WTRU can transmit and re-transmit in them a certain number of times, or until a cause of resource reselection is triggered.

The mode-2 sensing procedure can select and then reserve resources for a variety of purposes reflecting that NR V2X introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block. Alternatively, it may select resources to be used for the initial transmission of a later transport block, in which case the resources are indicated in an SCI scheduling a current transport block. Finally, an initial transmission of a transport block can be performed after sensing and resource selection, but without a reservation.

The first-stage SCIs transmitted by WTRUs on the PSCCH indicate the time-frequency resources in which the WTRU will transmit a PSSCH. These SCI transmissions may be used by sensing WTRUs to maintain a record of which resources have been reserved by other WTRUs in the recent past to avoid future potential conflicts in autonomous selection of resources.

The sensing WTRU then selects resources for its (re-)transmission(s) from within a resource selection window. The window starts shortly after the trigger for (re-)selection of resources and cannot be longer than the remaining latency budget of the packet due to be transmitted. Reserved resources in the selection window with SL-RSRP above a threshold, may be excluded from being candidates by the sensing WTRU, with the threshold set according to the priorities of the traffic of the sensing and transmitting WTRUs. Thus, a higher priority transmission from a sensing WTRU can occupy resources which are reserved by a transmitting WTRU with sufficiently low SL-RSRP and sufficiently lower-priority traffic.

Bandwidth Parts (BWPs) are defined for the sidelink in a similar way as for UL/DL, to provide a convenient way to specify aspects relating to a WTRUs RF hardware chain implementation. A WTRU is configured with one active sidelink BWP when in connected mode to a gNB, which is the same as the single sidelink BWP used for idle mode or out-of-coverage operation.

The subcarrier spacing used on sidelink is provided in the sidelink BWP (pre-)configuration, from the same set of values and associations to frequency ranges as for the Uu interface (i.e., 15, 30, or 60 kHz for FR1; and 60 or 120 kHz for FR2). Sidelink transmission and reception for a WTRU are thus contained within a sidelink BWP, and the same sidelink BWP is used for both transmitting and receiving. This means that resource pools, e.g., S-SSB, etc., must also be contained within an appropriate sidelink BWP from the WTRU's perspective.

For new radio (NR) and new radio operation in unlicensed frequency bands (NR-U), in order to support a wide range of services, 5G NR systems focus is on flexibility to meet the connectivity requirements of a range of existing and future (as yet unknown) services to be deployable in an efficient manner. In particular, NR considers supporting potential use of frequency range up to 100 GHz.

Current NR specifications define operation for frequencies up to 52.6 GHZ, where all physical layer channels, signals, procedures, and protocols are designed to be optimized for uses under 52.6 GHz. However, frequencies above 52.6 GHz are faced with more difficult challenges, such as higher phase noise, larger propagation loss due to high atmospheric absorption, lower power amplifier efficiency, and strong power spectral density regulatory requirements in unlicensed bands, compared to lower frequency bands. Additionally, the frequency ranges above 52.6 GHz potentially contain larger spectrum allocations and larger bandwidths that are not available for bands lower than 52.6 GHz.

As an initial effort to enable and optimize NR system for operation above 52.6 GHZ, studies have been investigating requirements for NR beyond 52.6 GHz, up to 114.25 GHZ, considering global spectrum availability and regulatory requirements (including channelization and licensing regimes), potential use cases and deployment scenarios, and NR system design requirements and considerations on top of regulatory requirements. Certain potential use cases involve: high data rate eMBB, mobile data offloading, short range high-data rate D2D communications, broadband distribution networks, integrated access backhaul (IAB), factory automation, industrial IoT (IIoT), wireless display transfer, augmented reality (AR)/virtual reality (VR) wearables, intelligent transport systems (ITS) and V2X, data center inter-rack connectivity, smart grid automation, private networks, and support of high positioning accuracy. The use cases span over several deployment scenarios including, but not limited to, indoor hotspot, dense urban, urban micro, urban macro, rural, factor hall, and indoor D2D scenarios. The study also identified several system design requirements around waveform, MIMO operation, device power consumption, channelization, bandwidth, range, availability, connectivity, spectrum regime considerations, and others.

Among the frequencies of interest, frequencies between 52.6 GHz and 71 GHz are especially interesting relatively in the short term because of their proximity to sub-52.6 GHz, for which the current NR system is optimized and the imminent commercial opportunities for high data rate communications, e.g., unlicensed spectrum, but also licensed spectrum between 57 GHz and 71 GHz.

Current frequency resources used for NR include: FR1 spanning from 410 MHz to 7.125 GHz; and FR2 spanning from 24.25 GHz to 52.6 GHz.

The proximity of the new frequency range (57-71 GHZ) to FR2, and the imminent commercial opportunities for high data rate communications, makes it compelling to address potential operation in this new frequency regime. In order to minimize the burden of change and maximize the leverage of FR2-based implementations, a decision has been made to extend FR2 operation up to 71 GHz with the adoption of one or more new numerologies (e.g., larger subcarrier spacings, etc.). New numerologies will be identified for NR>52.6 GHz and NR-U procedures designed for operation in unlicensed spectrum will also be leveraged towards operation in the unlicensed 60 GHz band. Thus, future NR operation may support frequency resources up to 71 GHz in both licensed and unlicensed operation. Similar to NR and NR-U operations below 52.6 GHZ, NR/NR-U operation in the 52.6 GHz to 71 GHz may be stand-alone or aggregated via carrier aggregation (CA) or dual connectivity (DC) having an anchor carrier.

In New Radio Unlicensed (NR-U), the supported numerology (e.g., subcarrier spacing (SCS) can be set as 15, 30 and 60 KHz. respectively. Listen-before-talk (LBT) bandwidth is set to 20 MHz in NR-U. Based on the minimum LBT bandwidth in NR-U that must be supported, the DL initial BWP is nominally 20 MHz, whereas the maximum supported channel bandwidth is set to 100 MHz. The WTRU channel bandwidth (or an activated BWP) can be set as an integer multiple of LBT bandwidth (i.e. 20 MHz). For instance, for SCS=30 KHz, the total allocated PRB numbers for 20 MHz, 40 MHz and 80 MHz bandwidth is equal to 48, 102, and 214, respectively.

In unlicensed band operation, a WTRU needs to sense the channel and make sure the channel is available before performing a transmission, which is referred to as listen-before-talk (LBT). Various LBT types have been defined to support different scenarios, e.g., LBT type 1 channel access, type 2A channel access, type 2B channel access, etc. If the channel's energy level is below the defined threshold, e.g., LBT succeeded, the WTRU may transmit within the duration of the channel occupancy time (COT). Once the COT is expired, the WTRU is required to perform the LBT again before any further transmission.

Recent developments for NR cover sidelink communication with FR1 unlicensed channel access (no beam management) and FR2 licensed operation with beam management. For mode-1, the sidelink operation on unlicensed spectrum is considered with Uu (i.e. air interface between a network node such as gNB and Tx WTRU) operation using licensed spectrum. It is restricted that the gNB will not perform any channel access. As mentioned previously, one of the challenges that remains to be addressed is for mode-1 is operating the sidelink on unlicensed spectrum with both Uu operation using unlicensed spectrum and sidelink operation using unlicensed spectrum.

When both the Uu interface and the sidelink operate in unlicensed bands, channel access is required on both the Uu and sidelink for SL mode-1 operation to complete a SL transmission scheduled by the base station through the Uu link. One potential solution is for the Uu and sidelink to perform channel access independently. However, due to the channel uncertainty on both Uu and sidelink, the gNB's SL scheduling on sidelink unlicensed frequency may be inaccurate and inefficient. This is not only because of the SL channel access has uncertainty, but also because of the channel access uncertainty on Uu interface and the inability of the scheduler at the base station to either timely receive feedback (e.g. BSR, SR, SL FARQ feedback) related to communication on sidelink, or to timely transmit scheduling information to Tx WTRU.

To address one or more of these issues, embodiments are disclosed herein which support the gNB to improve scheduling on the sidelink unlicensed spectrum. In this disclosure, several embodiments for channel access with assistance information are detailed. Embodiments detailing methods and apparatuses for channel access in operation of sidelink mode-1 with both Uu unlicensed and sidelink unlicensed bands, may generally include: (1) Channel access procedures for Unlicensed SL Mode-1 and Unlicensed Uu without assistance information, but with early indication to send LBT failure; (2) Channel access procedures for Unlicensed SL Mode-1 and Unlicensed Uu with assistance information from the Tx WTRU; (3) Channel access procedures for Unlicensed SL Mode-1 and Unlicensed Uu with assistance information from the Rx WTRU; and/or (4) Channel access procedures for Unlicensed SL Mode-1 and Unlicensed Uu with assistance information from both the Rx WTRU and the Tx WTRU.

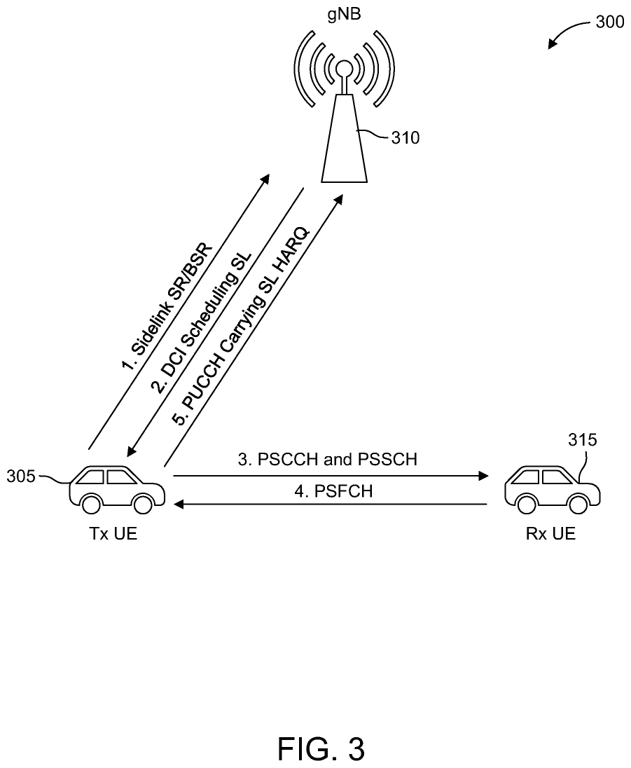

Referring to FIG. 3, an example scenario 300 is shown for channel access for SL-U mode-1. Tx WTRU 305 needs to get a grant from the gNB 310 to perform a sidelink transmission to Rx WTRU 315. In FIG. 3, an example of sidelink mode 1 operation using dynamic scheduling is shown, where In step 1, when the Tx WTRU 305 has data to be transmitted a Rx WTRU 315, the Tx WTRU 305 sends a sidelink scheduling request (SL-SR) or the sidelink buffer status report (SL-BSR) to get a resource grant from the gNB 310.

In step 2, once the gNB 310 receives the SL-SR or the SL-BSR, it uses downlink control information (DCI), e.g., DCI format 3_0, to indicate the resource allocation for the SL transmission and other sidelink grant-related information to the Tx WTRU 305.

In step 3, after receiving the scheduling for the sidelink (SL), the Tx WTRU 305 performs the scheduled physical sidelink control channel (PSCCH) and physical sidelink shared channel (PSSCH) transmission to the Rx WTRU 315 as specified by the grant of SL resources by the gNB 310 in step 2.

In step 4, the Rx WTRU 315 monitors the transmission of the PSCCH and the corresponding PSSCH. If HARQ feedback is enabled for the PSSCH transmission, the Rx WTRU 315 sends the HARQ feedback to the Tx WTRU 305 using the enabled HARQ scheme through the physical sidelink feedback channel (PSFCH).

In step 5, after receiving the HARQ feedback from the Rx WTRU 315, the Tx WTRU 305 forwards the HARQ feedback result of the SL transmission to the gNB 310 using the physical uplink control channel (PUCCH). Then, the gNB 310 can make decisions and schedule subsequent resources for SL transmission based on the received HARQ feedback result from Rx WTRU 315 via Uu link with the Tx WTRU 305.

When sidelink unlicensed (SL-U) mode-1 is operating with both Uu and sidelink in unlicensed spectrum, it requires channel access on both the Uu interface and the PC5 (SL) interface to perform the transmission. For example, channel access on Uu interface is needed to transmit the sidelink scheduling request (SR) and sidelink buffer status report (BSR), the scheduling DCI, the PUCCH, etc. Furthermore, channel access on the PC5 interface is needed for SL communication such as the PSCCH, PSSCH, PSFCH, etc.

Regulation requires a transmitting node, e.g., gNB 310, Tx WTRU 305, Rx WTRU 315, etc., to perform channel access before performing a transmission on the unlicensed spectrum (also denoted herein as shared spectrum). Channel access requires the transmission node to perform sensing on the channel for a certain period of time. This is referred to as LBT. If the channel is sensed to be idle for at least a certain sensing interval, also denoted as LBT success, the transmission node can perform the transmission on the unlicensed spectrum. If not, e.g., the channel is sensed to be not idle, it is denoted as LBT failure. Then, the transmission node cannot perform the transmission on the unlicensed spectrum when the LBT has failed. Hereinafter, LBT is used to denote the procedures a transmission node uses to “access the channel” or perform “channel access.” It should be noted that the term LBT may be interchangeable with channel sensing, and other notations of channel access schemes.

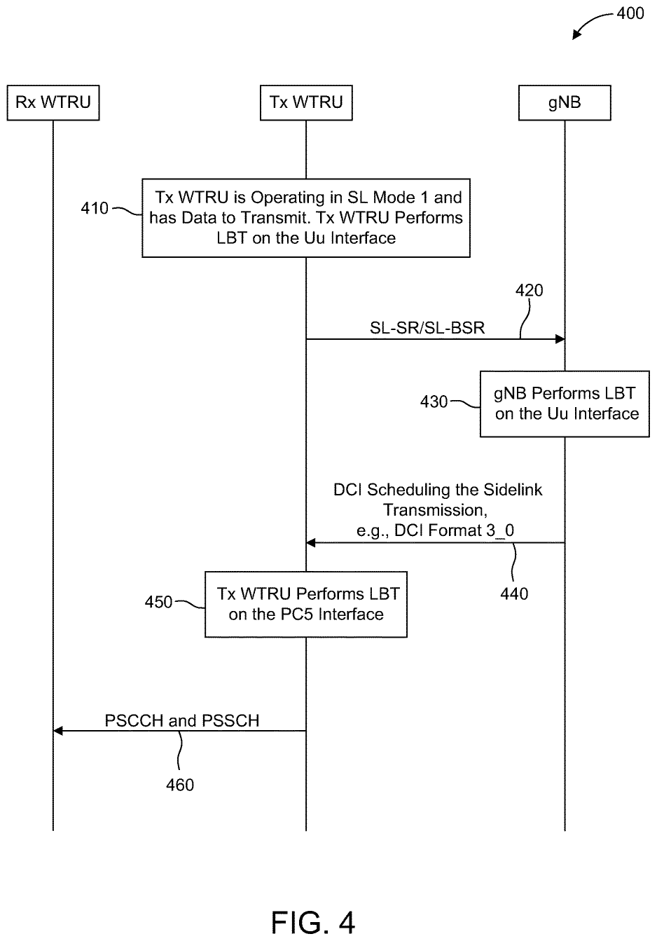

FIG. 4 is a sequence diagram representing an example embodiment for a method 400 of communicating in a wireless network using a channel access procedure for SL-U when both the Uu and the sidelink use unlicensed frequency resources.

At 410, the Tx WTRU, also referred to herein as a relay WTRU, has data to transmit on a sidelink/PC5 interface to a Rx WTRU, also referred to herein as a remote WTRU, the Tx WTRU can perform LBT on the Uu to communicate with the gNB for gaining sidelink resource information. At 420, the Tx WTRU can send the SL-SR or the SL-BSR to the gNB when the LBT is successful. At 430, after receiving the SL-SR or the SL-BSR, the gNB can perform LBT on the Uu and at 440, the gNB can send the DCI carrying the sidelink scheduling information to the Tx WTRU when the LBT has succeeded. At 450, after receiving the DCI, the Tx WTRU performs LBT on the sidelink before transmitting on the SL resource allocated by the gNB to the Rx WTRU. At 460, if the LBT has succeeded, the Tx WTRU transmits the scheduled PSCCH and PSSCH to the Rx WTRU over the PC5 SL. If the LBT has failed, the Tx WTRU cannot perform the scheduled sidelink transmission. In this case, the Tx WTRU needs to inform the gNB that the scheduled sidelink transmission is not performed due to LBT failure and request another resource scheduling.

As can be seen, Step 450 and step 460 of FIG. 4 can be repeated for each of the scheduled grants received in the DCI, e.g., for the SL retransmissions or the repetitions scheduled by the same DCI, or the Tx WTRU can only indicate the LBT failure to the gNB after performing the LBT for the last retransmission(s) or repetition when the LBT for all the transmission and retransmissions scheduled by the same DCI failed, or when the LBT for all the transmission and repetitions scheduled by the same DCI failed.

In one example embodiment, the Tx WTRU can still use the PUCCH resource scheduled by the received DCI. The Tx WTRU can use the PUCCH to indicate the LBT(s) that failed. By doing so, the gNB can be aware of the exact reason for the retransmission. For example, when SL LBT failure is indicated in the PUCCH, the retransmission is due to LBT failure(s) and Tx WTRU didn't perform the actual scheduled sidelink transmission. When a negative acknowledgement (NACK) is indicated in the PUCCH, the retransmission is due to the NACK from the Rx WTRU but that the Tx WTRU actually performed the scheduled sidelink transmission. The current PUCCH resource indicated in the DCI scheduling the sidelink transmission can only carry 1-bit of information. If the option of LBT failure also needs to be carried, the PUCCH resource needs to be modified and the information carried by the PUCCH need to be increased to 2-bits or more. For example, ‘00’ indicates ACK, ‘01’ indicates NACK, ‘10’ indicates LBT failure, ‘11’ is reserved.

Upon reception of this feedback, the gNB may schedule the SL (re) transmissions of the Tx WTRU according to the feedback value. For instance, when a NACK is received, the scheduler typically reduces the rate of the SL transmission (e.g., lowers its modulation and coding scheme (MCS) index) and applies different HARQ Redundancy values or toggles the new data indicator (NDI). When the scheduler receives an LBT failure indication, it may keep the same rate, same HARQ RV and should not toggle the new data indicator (NDI). The gNB may also consider that the SL BWP used by the WTRU is busy and may schedule resources for the WTRUs of the same SL BWP accordingly (e.g., by planning multiple retransmissions within a grant to allow multiple LBT attempts) or decide to switch some of these WTRUs to another SL BWP or carrier.

In another example embodiment, when the SL LBT is failed, the Tx WTRU can send NACK to the gNB using the PUCCH resources. In this scenario, the gNB cannot distinguish whether it is due to a SL LBT failure or due to the NACK from the Rx WTRU when receiving a NACK from the Tx WTRU. In both cases, what is required by the Tx WTRU, is asking the gNB for scheduling other resources to perform the retransmission for the same TB. Accordingly, the reason for retransmission can be transparent to the gNB.

In a compatible example embodiment, uplink signaling is enhanced to provide an explicit indication of channel access success/failure (LBT success/LBT failure) on the sidelink. This signaling can be introduced as a new uplink control information (UCI), and can be transmitted over a PUCCH resource. In some embodiments, this resource can be configured by the network as dedicated for SL channel access indication, as a configured timing offset after the LBT or with a timing indicated in the received SL grant. In this way, the SL Tx WTRU may perform a very quick update to the gNB regarding the SL channel access outcome. To optimize the power overhead for the SL Tx WTRU, this transmission can be configured to be NACK only, where for example, the SL Tx WTRU will only transmit the indication in case of SL channel access failure. A further optimization to reduce the UL resource overhead may be achieved by making the same resource configurable for multiple WTRUs, which the network may choose to be identifiable either with the timing of the SL resource, or separate codes may be assigned to different WTRUs as part of their configuration. Various combinations are also possible.

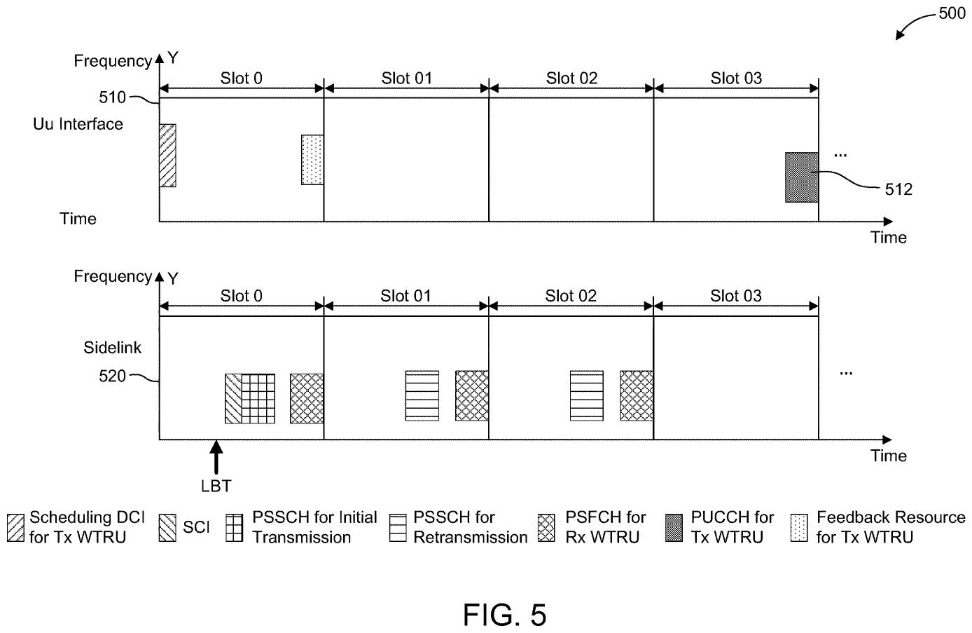

However, since the sidelink transmission can be scheduled with several repetitions, using the PUCCH to report the LBT status, might introduce additional delay to the system. Thus, in some embodiments, it is desired to not wait for the scheduled PUCCH resource, and transmit the indication of LBT failure earlier. An example embodiment with this capability is shown and described in reference to FIG. 5.

FIG. 5 is an example illustrating timing and resources 500 for unlicensed Uu channel 510 and unlicensed sidelink channel 520. The gNB can schedule some resources that differ from, and located earlier in time domain than, the scheduled PUCCH resource 512 for the Tx WTRU to send the LBT result indication to the gNB. In one embodiment, sidelink LBT result indication to the gNB can be a HARQ feedback, or a reference signal or a pre-defined sequence (or combination thereof). For example, in one embodiment, the gNB can schedule another PUCCH resource (not shown) for the Tx WTRU to send feedback of the LBT result to the gNB. When the LBT for the scheduled sidelink transmission fails, the Tx WTRU can send a NACK to the gNB to indicate the LBT is failed, and another scheduling grant is needed. When the LBT is successful, the Tx WTRU can send an ACK to the gNB to indicate the same. Alternatively, when the LBT is successful, the Tx WTRU might not send any indication to the gNB, for which the gNB presumes a successful sidelink LBT channel access to the Rx WTRU. When the gNB receives nothing on the PUCCH 512, the gNB defaults that the LBT is successful, and no retransmission needs to be scheduled. In one example, the gNB can distinguish whether a received NACK is for LBT failure indication or for reporting a NACK received from the Rx WTRU, by the timing of receiving the NACK. For example, if it is received in the earlier resource, the NACK represents an LBT failure indication. If the NACK is received in the later PUCCH resource 512, it represents the NACK from the Rx WTRU.

When the Tx WTRU sends the LBT failure indication to the gNB, the Tx WTRU can perform LBT to access the channel on the Uu with the gNB. Alternatively, the LBT failure indication can be categorized as short control signaling and the exempt rule can be applied. For example, the Tx WTRU can directly transmit the LBT failure indication to the gNB and doesn't need to perform LBT on the Uu prior to doing so. Alternatively, the Tx WTRU might perform a short LBT on the Uu, e.g., a type-2 channel access, to transmit a SL LBT indicator.

In some embodiments, to assist the gNB in understanding of a channel condition on the sidelink, and thus make improved decisions in allocating resources for sidelink transmission, an enhanced channel access embodiment to the example shown in FIG. 4 is disclosed. In this example, the gNB can perform LBT on both the Uu and the sidelink before sending the scheduling DCI. In performing LBT on the sidelink as well, the gNB can better predict which sidelink resources may be more suitable for the sidelink transmissions.

Embodiments for enhanced channel access may alter the steps shown in FIG. 4 as follows. Step 410 and step 420 may be the same, however, at step 430, after receiving the SL-SR or the SL-BSR, the gNB can perform LBT on the Uu and the sidelink (not shown). The LBT on the Uu is used to determine when the channel on Uu is available to send the grant/schedule in the scheduling DCI to the Tx WTRU, and the LBT on the sidelink may be used to determine whether the channel on sidelink is available or to predict whether the scheduled sidelink transmission can be performed in a certain resource. Steps 440, 450 and 460 shown in FIG. 4, would be the same as shown. If the LBT for transmitting the scheduled sidelink transmission from the Tx WTRU fails, regardless of which variation is used, the Tx WTRU can send a SL LBT indication to the gNB to inform of the same, as before. The various embodiment proposed above for Tx WTRU sending the SL LBT failure indication may also be applied.

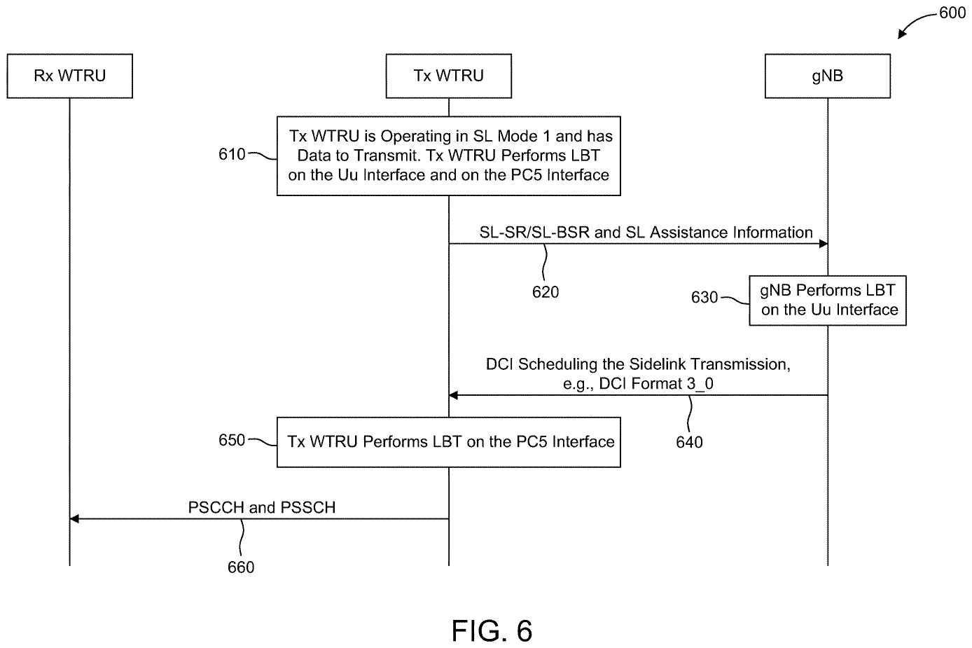

Referring to FIG. 6, further embodiments for a method 600 of channel access with SL assistance information for SL-U mode 1 will now be described. Since the actual sidelink transmission is performed by the Tx WTRU (or relay WTRU), the channel condition between the Tx WTRU and Rx WTRU can be different from the channel condition between Tx WTRU and the gNB. Thus, the LBT for the sidelink performed by the gNB can generally determine the sidelink channel availability around the gNB, which may not be the same as the actual sidelink channel availability between Tx WTRU and Rx WTRU. Accordingly, the LBT results at the transmitter side can be inaccurate due to, for example, the hidden node issue. Embodiments shown in FIG. 6 may alleviate those difficulties by providing channel access with assistance from the Tx WTRU.

As shown in FIG. 6, a method 600 for communicating in a wireless network using unlicensed band sidelink and unlicensed band network, or Uu, air interfaces, may generally include:

In step 610, the Tx WTRU can perform LBT on the Uu with the gNB and on the sidelink with the Rx WTRU. The LBT on the Uu is used to determine when the channel on Uu is available to send the SL-SR, SL-BSR and/or the assistance information to the gNB. The LBT on the sidelink is used to determine which channel on the sidelink is available to help the gNB select the sidelink scheduling.

Next, the Tx WTRU sends 620 the SL-SR or the SL-BSR, and/or the assistance information to the gNB when the LBT on the Uu is successful. Alternatively, the assistance information can be categorized as short control signaling and the Tx WTRU can directly send it to the gNB as mentioned previously, and does not need to perform LBT for transmitting assistance information, e.g., type 2C channel access. Alternatively, the assistance information can be transmitted with a short LBT, e.g., using type 2A channel access procedure with a sensing interval of 25 us, or using type 2B channel access procedure with a sensing interval of 16 us. The channel access procedure for transmitting the channel availability assistance information disclosed here may be applied to all the channel availability assistance information disclosed in the various different embodiments herein.

In one embodiment, the assistance information can comprise of one or multiple of the following information to help the gNB select the sidelink scheduling resources:
Channel available starting time: the Tx WTRU can indicate the starting time when the channel will be available. For example, the Tx can predict when the channel will be available and send the predicted time to the gNB. The Tx WTRU can send a time offset in the assistance information to indicate the time offset between the starting of the available channel and the time of sending the assistance information. Alternatively, the Tx WTRU can indicate one or more of the frame index, subframe index, slot index, and symbol index in the assistance information to indicate the starting time location of the available channel. Alternatively, the Tx WTRU can use a bit map to indicate which time resources are available. Each bit map can be associated with one frame, one subframe, one slot, or one symbol. Any combination of this assistance information is also possible. In another example, the Tx WTRU can send the time that the channel was available. For example, the Tx WTRU can send which time the channel was available in a past time window. The duration of the window can be configured by the gNB through RRC signaling. The Tx WTRU can send the channel was available in which time resources during this window to the gNB, e.g., through a bitmap, etc., as the assistance information.
Available Candidate Resources: The SL Tx WTRU can indicate a set of candidate resources (sub-channels with slot indications) which it estimates to be available to the base station. As SL devices are listening over the SL to potentially receive the incoming transmissions which may be transmitted by other SL devices operating in Mode-1 or Mode-2, they can derive an accurate estimate of which channel resources may be occupied or available over the SL. This information can be combined with the unlicensed SL channel availability to prepare a list of available candidate resources that SL Tx WTRU expects to be available for its transmission. For instance, channel monitoring for SL data reception gives the indication of the reserved transmission time and frequency resources, and thus the Tx WTRU can derive a list of available or non-available time in the future.
Channel busy time: the Tx WTRU can indicate the time that the SL channel was busy. For example, the Tx WTRU can send which time the channel was busy in a past time window. The duration of the window can be configured by the gNB through RRC signaling as desired. The Tx WTRU can send the channel was busy in which time resources during this window to the gNB, e.g., through a bitmap, etc., as the assistance information
Channel available duration: the Tx WTRU can send the duration that the channel may be available. For example, the Tx WTRU can indicate the one or more of symbol duration, slot duration, subframe duration and frame duration to the gNB to assist the gNB in sidelink resource scheduling.
Channel busy ratio: the TX WTRU can send the channel busy ratio in a past time window to the gNB, where the duration of the window can be configured by the gNB through RRC signaling. The channel busy ratio can be indicated as the percentage of the channel busy rate. For example, X is indicated if the channel busy rate is x % in the past time window. Or the channel busy ratio can be indicated as a quantized value. For example, 1/4, 2/4, 3/4, 4/4 etc. Or the channel busy ratio can be indicated as channel busy level. For example, high, medium, low, etc. Various designations are possible for reporting the concept to assist the SL scheduling.
Available sub-band indicator: the Tx WTRU can indicate which frequency band for SL is available to the gNB. For example, the frequency band, e.g., sidelink BWP, that the WTRU is operating with for the sidelink mode-1 can be divided into multiple sidelink sub-bands. Each sidelink sub-band can be associated with a certain number of bandwidths, e.g., 20 MHz; or can be associated with a certain number of subchannel, e.g., k subchannels where k can be configured by the gNB through RRC signaling. The Tx WTRU can indicate the available sidelink sub-bands to the gNB. For example, a bit map can be used to indicate which sidelink sub-bands are available among all of them.

The method may continue where the gNB uses the assistance information sent by the Tx WTRU to select the sidelink scheduling resources. In one embodiment, the gNB can perform LBT 630 on the Uu only to determine when to send 640 the DCI carrying the sidelink scheduling information. Alternatively, the gNB can perform LBT on both the Uu and sidelink, and in this case, the gNB can further use the LBT result on the sidelink to help it make the sidelink scheduling decision. Steps 640-660 are similar to those described in reference to FIG. 4.

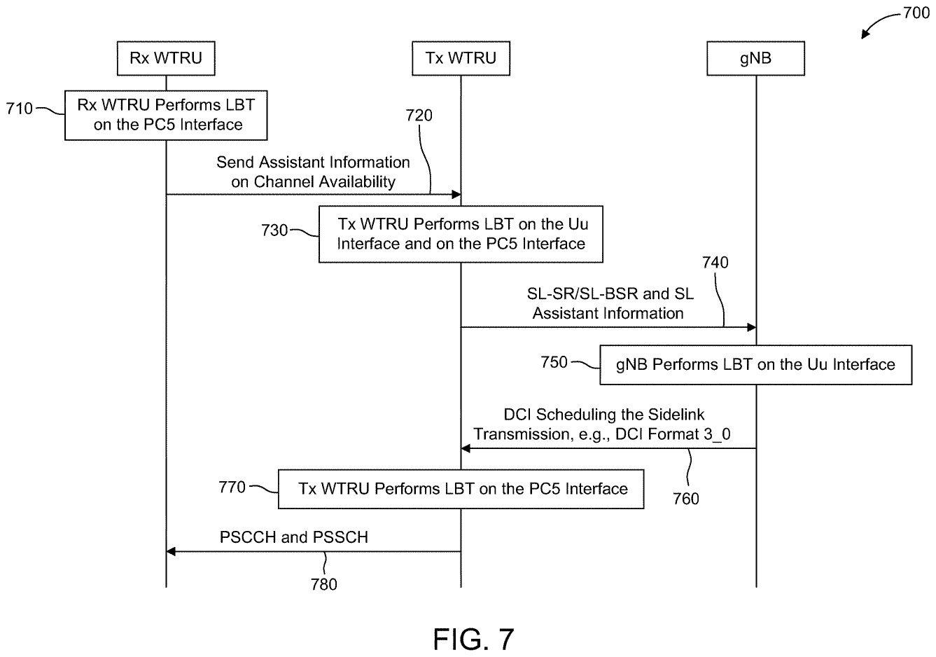

In further embodiments, referring to FIG. 7 method 700, to improve accuracy of the channel availability, e.g., to avoid the hidden node issue, the Rx WTRU may also provide the assistance information for gNB scheduling SL resources. For example, the Rx WTRU can perform LBT 710 on the sidelink and send 720 the assistance information to the Tx WTRU. The prior examples sending for channel access assistance information sent by the Tx WTRU to the gNB can be applied here, or modified specifically identifying assistance information received from the Rx WTRU.

The method 700 of communicating in a wireless network using unlicensed SL mode-1 and unlicensed Uu according to some embodiments, may reflect the channel access procedure with assistance from the Rx WTRU as shown in FIG. 7. As shown, the Rx WTRU can perform LBT 710 or channel monitoring on the PC5 interface to collect channel availability assistance information and determine when it may send the assistance information to the Tx WTRU.

Next, the Rx WTRU sends 720 the SL assistance information to the Tx WTRU when the LBT on the sidelink is successful. The assistance information can be one or multiple of the information previously described, including: channel available time, channel busy time, channel available duration, channel busy ratio, available sub-band indicator or other information that may be useful for gNB selecting resources for SL transmission.

In one embodiment, the SL scheduling assistance information from Rx WTRU may comprise an indication of preferred or suggested resources. These might be, for example, the resources where Rx WTRU is listening and not monitoring the channel in other resources to save power. In another example, the preferred resources may be the only ones available when the Rx WTRU is busy and has heavy traffic in reception/transmission.

In another example embodiment, the assistance information from Rx WTRU can comprise an indication of non-preferred resources which the gNB should avoid in selecting SL resource scheduling. These resources could be the ones where Rx WTRU has duplexing constraints, for example, or resources where Rx WTRU intends to go in DRX mode for power saving. Other reasons may be identified or excluded, for example, these could be the resources where there is interference from the same RAT or different RAT communication. The SL scheduling assistance information from Rx WTRU can be one or any combination of the above information. The SL scheduling assistance information can be provided on a periodic basis when the devices are operating over the unlicensed SL, or the Rx WTRU may send 720 the assistance information in response to an explicit request from the SL Tx WTRU or relayed from the gNB. In another embodiment, the Rx WTRU may decide on its own to send 720 SL resource assistance information to the SL Tx WTRU, e.g., in case when the SL Rx WTRU has some serious duplexing ahead or power saving constraints.

In one example embodiment, the transmission 720 of the channel availability assistance information can be triggered by the occasion of a sidelink transmission that needs to be performed, and the Rx WTRU is the destination WTRU or is one of the destination WTRUs. For example, when the Tx WTRU has data to be transmitted on the sidelink, the Tx WTRU can send a trigger to the destination WTRU to trigger it to provide channel availability information to it. After receiving the trigger from the Tx WTRU, the Rx WTRU perform LBT 710 on the sidelink and provide 720 the channel availability assistance information to the Tx WTRU.

In another example, the Rx WTRU can periodically perform the LBT 710 on the sidelink and provide 720 the channel availability assistance information to the Tx WTRU regardless of whether there is a sidelink transmission intended for it. In this example, no trigger for sending 720 channel availability assistance information to the Tx WTRU is needed.

After receiving the SL channel assistance information from the Rx WTRU, the Tx WTRU can directly send it as one, or part of, the assistance information it sends to the gNB. In one embodiment, the Tx WTRU doesn't perform LBT on the sidelink to add additional assistance information. The Tx WTRU will only LBT on the Uu 730 and send 740 the channel availability assistance information to the gNB based on what has been received from the Rx WTRU.

In yet other embodiments, the Tx WTRU can perform LBT on both Uu and sidelink. The Tx WTRU can also perform LBT on the sidelink and update the assistance information based on its LBT result. The Tx WTRU can send 740 the updated channel availability assistance information to the gNB when the LBT on the Uu is successful. Steps 740-780 of FIG. 7 are similar to steps 620-660 described in FIG. 6 and thus not separately described again.

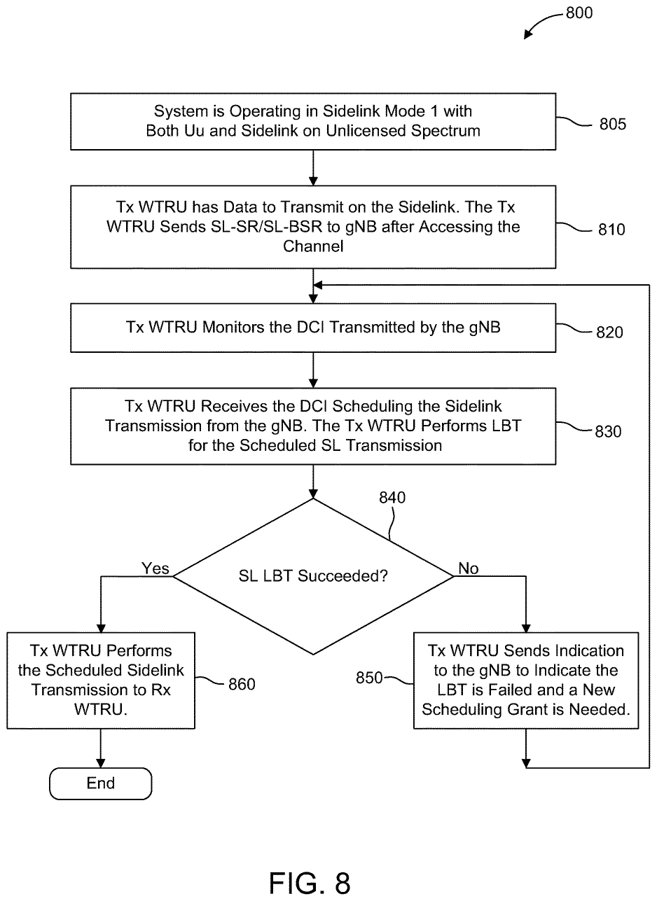

Referring to FIG. 8, a method 800 includes a WTRU operating 805 in sidelink mode 1 with both Uu in unlicensed spectrum and sidelink in unlicensed spectrum. A Tx WTRU that has data to transmit on the sidelink accesses the Uu channel and sends 830 the SL-SR/SL-BSR to the gNB. The Tx WTRU monitors 820 the DCI from the gNB and when received, performs LBT 830 on the SL channel associated with the received scheduled SL resources. In this example, the Tx WTRU has been assigned with an additional resource by the gNB for sending the LBT failure indication for a scheduled sidelink transmission. If 840 the LBT for the scheduled sidelink transmission from the Tx WTRU fails, the Tx WTRU sends 850 indication on the indicated resource to let the gNB know the LBT is failed on the Tx WTRU side, and the scheduled sidelink transmission cannot be performed. If 840 the LBT is successful on the SL channel associated with the received scheduled SL resources, the Tx WTRU transmits 860 SL data to the Rx WTRU using the scheduled SL resources received from the gNB.

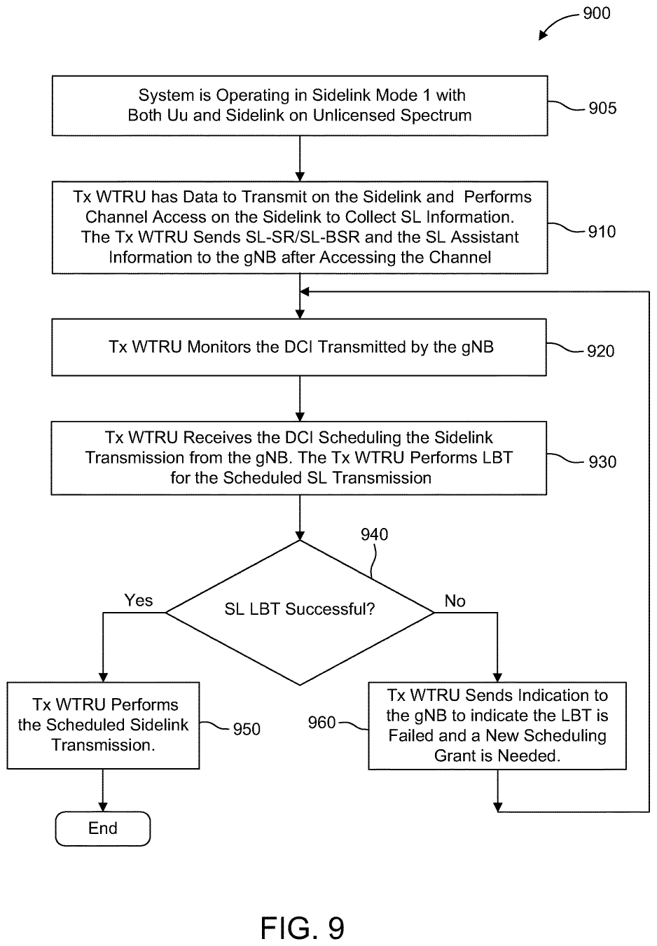

As shown in FIG. 9, another example embodiment for a method 900 of a WTRU operating 905 in unlicensed sidelink mode-1 with unlicensed Uu is shown. In method 900, when the Tx WTRU has data to transmit on the sidelink, the Tx WTRU performs channel access (LBT) on the sidelink and collects SL assistance information and sends 910 the SL assistance information to the gNB after accessing the Uu channel, to assist the gNB in sidelink scheduling. The assistance information can comprise one or more of the information previously discussed, such as, channel available starting time, available candidate resources, channel busy time, channel available duration, channel busy ratio, available sub-band indicator, etc. Next, the WTRU monitors 920 for DCI from the gNB, and when received, performs LBT 930 on the SL cannel associated with the scheduled sidelink resources designated in the DCI. If 940 the LBT is successful, the Tx WTRU performs 950 the SL transmission as scheduled. If 940 LBT is unsuccessful, the Tx WTRU sends 960 an indication of SL LBT failure, requesting new SL scheduling resources as in embodiments previously discussed.

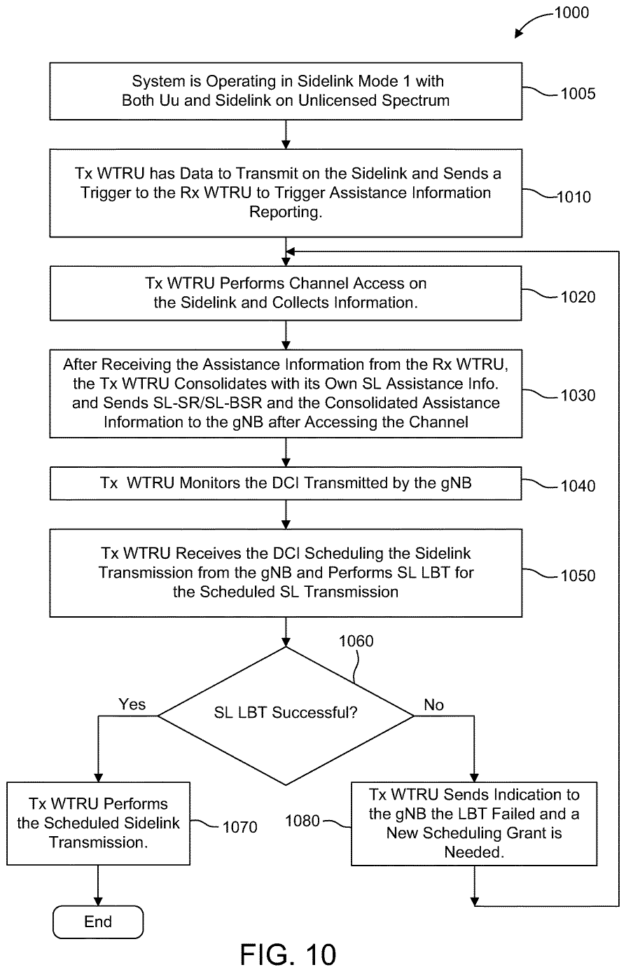

FIG. 10 shows an alternate embodiment of a method 1000 of WTRU communication. The Tx WTRU is operating 1005 in SL mode 1 with both Uu and SL on shared/unlicensed spectrum, as in other embodiments. In this embodiment, when a Tx WTRU has data to transmit on the sidelink, the Tx WTRU sends 1010 a trigger to the Rx WTRU to collect the SL assistance information and performs 1020 its own LBT channel access for the sidelink. Once the Tx WTRU receives the assistance information from the Rx WTRU, the Tx WTRU may consolidate SL assistance information from the combination of what is received from Rx WTRU and its own, e.g., derived from communicating on the SL, and, after channel access to the Uu, and forwards 1030 the consolidated SL assistance information to the gNB to assist the gNB in sidelink resource scheduling. Thereafter, steps 1040-1080 of FIG. 10 are similar to steps 920-960 of FIG. 9.

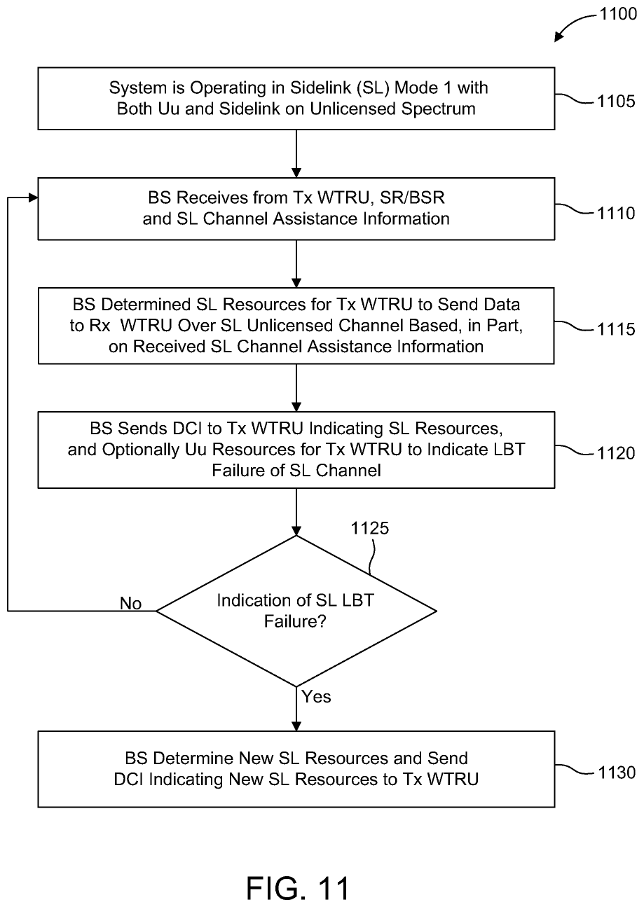

FIG. 11 shows a method 1100 of operating 1105 in SL mode 1 with both Uu and SL on shared/unlicensed spectrum from a network node, e.g., base station, according to an embodiment. The base station receives 1110 a SR/BSR and SL channel assistance information from a Tx WTRU. The base station then determines 1115 SL resource scheduling for the Tx WTRU to send data to an Rx WTRU over the SL-U channel based, at least in part, on the received SL channel assistance information. Next, the base station sends 1120 DCI to the Tx WTRU indicating the determined SL information. If 1125, the base station receives indication of LBT failure on the SL channel by the Tx WTRU, the base station will determine 1130 new SL resources and send DCI indicating the new SL resources to the Tx WTRU. Otherwise, the base station will wait to receive 1110 another scheduling request or buffer status report from the Tx WTRU and repeat the process. Although not shown, the base station may perform LBT on the Uu channel and/or SL-U channel and/or provide a channel occupancy time, as described in previous embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless transmit receive unit (WTRU), the method comprising:
monitoring a sidelink (SL) channel for communicating with a second WTRU in unlicensed SL mode-1 and collecting SL assistance information relating to the SL channel;
transmitting to a base station, over an unlicensed Uu band, one or more of a SL scheduling request (SR) or a SL buffer status report (BSR) and the SL channel assistance information;
receiving downlink control information (DCI) from the base station indicating SL resource scheduling;
performing listen-before-talk (LBT) on the SL channel associated with the indicated SL resource scheduling; and
sending a transmission, wherein the transmission is: (1) to the base station, on a condition LBT is unsuccessful, at least one of indication of LBT failure or a request for new SL resource scheduling; or (2) to the second WTRU, on a condition LBT is successful, SL data using the indicated SL resource scheduling.

2. The method of claim 1, wherein prior to transmitting to the base station, the method comprises at least one of performing LBT on the unlicensed Uu band or receiving an indication of a channel occupancy time (COT).

3. The method of claim 1, wherein the SL assistance information comprises one or more of a SL channel available start time, available SL candidate resources, a SL channel busy time, a SL channel available duration, a SL channel busy ratio (CBR) or an available SL sub-band indicator.

4. The method of claim 3, wherein the SL assistance information further comprises information regarding the SL channel received from the second WTRU.

5. The method of claim 4, wherein the information regarding the SL channel received from the second WTRU comprises one or more of channel available time, channel busy time, channel available duration, channel busy ratio, available sub-band indicator of the SL channel or suggested resources for SL communication with the WTRU.

6. The method of claim 1, wherein on the condition LBT is unsuccessful, the method further comprises:
receiving second DCI from the base station indicating new SL resource scheduling;
performing a second LBT on the SL channel associated with the indicated new SL resource scheduling; and
sending a second transmission, wherein the second transmission is: (1) to the base station, on a condition the second LBT is unsuccessful, at least one of indication of the second LBT failure or a second request for new SL resource scheduling; or (2) to the second WTRU, on a condition the second LBT is successful, SL data using the indicated new SL resource scheduling.

7. A wireless transmit receive unit (WTRU) comprising:
a transmitter, a receiver and a processor in communication with the transmitter and receiver, the transmitter, receiver and processor configured to:
monitor a sidelink (SL) channel for communicating with a second WTRU in unlicensed SL mode-1 and collect SL assistance information relating to the SL channel;
transmit to a base station, over an unlicensed Uu band, one or more of a SL scheduling request (SR) or a SL buffer status report (BSR) and the SL channel assistance information;
receive downlink control information (DCI) from the base station indicating SL resource scheduling;
perform listen-before-talk (LBT) on the SL channel associated with the indicated SL resource scheduling; and
send a transmission, wherein the transmission is: (1) to the base station, on a condition LBT is unsuccessful, at least one of indication of LBT failure or a request for new SL resource scheduling; or (2) to the second WTRU, on a condition LBT is successful, SL data using the indicated SL resource scheduling.

8. The WTRU of claim 7, wherein prior to transmitting to the base station, the transmitter, receiver and processor are configured to: perform LBT on the unlicensed Uu band or receive an indication of a channel occupancy time (COT) from the base station.

9. The WTRU of claim 7, wherein the SL assistance information comprises one or more of a SL channel available start time, available SL candidate resources, a SL channel busy time, a SL channel available duration, a SL channel busy ratio (CBR) or an available SL sub-band indicator.

10. The WTRU of claim 9, wherein the SL assistance information further comprises information regarding the SL channel received from the second WTRU.

11. The WTRU of claim 10, wherein the information regarding the SL channel received from the second WTRU comprises one or more of channel available time, channel busy time, channel available duration, channel busy ratio, available sub-band indicator of the SL channel or suggested resources for SL communication with the WTRU.

12. The WTRU of claim 7, wherein on the condition LBT is unsuccessful, the transmitter, receiver and processor are further configured to:
receive second DCI from the base station indicating new SL resource scheduling;
perform a second LBT on the SL channel associated with the indicated new SL resource scheduling; and
send a second transmission, wherein the second transmission is: (1) to the base station, on a condition the second LBT is unsuccessful, at least one of indication of the second LBT failure or a second request for new SL resource scheduling; or (2) to the second WTRU, on a condition the second LBT is successful, SL data using the indicated new SL resource scheduling.

13. A base station comprising:
a transceiver and a processor in communication with the transceiver, the transceiver and processor configured to:
receive from a wireless transmit receive unit (WTRU), over an unlicensed Uu band, one or more of a SL scheduling request (SR) or a SL buffer status report (BSR) and SL channel assistance information relating to an unlicensed SL channel between the WTRU and a second WTRU operating in unlicensed SL mode-1;
determine SL resource scheduling for SL data transmission by the WTRU based, at least in part, on the received SL channel assistance information;
send downlink control information (DCI) to the WTRU indicating the determined SL resource scheduling;
determine sidelink listen-before-talk (LBT) failure occurred based on indication from the WTRU;
determine second SL resource scheduling for the SL data transmission; and
send second DCI to the WTRU indicating the determined second SL resource scheduling.

14. The base station of claim 13, wherein determining SL resource scheduling is further based on the base station performing LBT on the unlicensed SL channel.

15. The base station of claim 13, wherein the transceiver and processor are further configured to:
provide a channel occupancy time (COT) based on a LBT performed on the unlicensed Uu band.

16. The base station of claim 13, wherein the SL assistance information comprises one or more of a SL channel available start time, available SL candidate resources, a SL channel busy time, a SL channel available duration, a SL channel busy ratio (CBR) or an available SL sub-band indicator.

17. The base station of claim 16, wherein the SL assistance information further comprises information regarding the SL channel received by the WTRU from the second WTRU.

18. The base station of claim 17, wherein the information regarding the SL channel received by the WTRU from the second WTRU comprises one or more of channel available time, channel busy time, channel available duration, channel busy ratio, available sub-band indicator of the SL channel or suggested resources for SL communication with the WTRU.
